(19) United States
(12) Patent Application Publication
(10) Pub. No.: US 2010/0258152 A1
(43) Pub. Date: Oct. 14, 2010

(54) Walker with Armrests

(76) Inventors: Fang-Sheng Lin, Yongkang City (TW); Dickson Su, Taipei City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/423,070

(22) Filed: Apr. 14, 2009

(51) Int. Cl. A61H 3/00

(52) U.S. Cl. 135/67; 135/69

(57) ABSTRACT

A walker with armrests has a pedestal including a first side frame, a second side frame and two bridging rods connecting between the first and second side frames to form a stable structure to the walker. The two side frames each has two foot rods and a top lateral rod extending between the two foot rods. Two armrests are mounted on the top lateral rods of the first and second side frames, respectively. Thereby, a physiotherapy patient may rest his armpits on the armrests to avoid leaning forward when holding the top lateral rods of the walker.

### BACKGROUND OF THE INVENTION

1. Field of the Invention

The present invention relates to a walker with armrests, and more particularly to a walker having multiple functions.

2. Description of Related Art

Many patients having weak or paralyzed legs or suffering apoplexy or leg handicap need walking accessories (i.e. walkers) to carry out walking training for physiotherapy, even not for physiotherapy, also need the walking accessories to move short distance in daily life.

Mostly, conventional walkers cannot provide stable support to patient's legs. As shown in FIG. 1, an improved conventional walker comprises two inverted U-shaped frames, a first side frame 41 and a second side frame 42, each having a top lateral rod 431 and two foot rods 432 extending from two ends of the top lateral rod 431. Two bridges 43 connect between the two side frames 41, 42 to construct a steric structure (no less than 3 supporting points) to provide stable support to help a patient during walking. However, this conventional walker still has a problem that the patient needs to lean forward to grip the top lateral rods, which are at lower positions. After keeping this leaning posture for a long time, patient's body will suffer pressure at its spine, arms and muscle for the whole upper body and thus get hurt and distortion.

Although another walking accessory without the foregoing problem, such as stick, has better mobility for patients, the stick only has one supporting point or small supporting area and thus has poor stability for use. The stick is only suitable for patients with minor walking problems.

### SUMMARY OF THE INVENTION

A main objective of the present invention is to provide a walker with armrests to make easy use for handicapped person or patients needing physiotherapy to avoid spine and muscle injure or distortion caused by leaning forward.

To achieve the foregoing objective, the walker with armrests comprises:

a pedestal having two side frames and a connecting portion between the two side frames, each of the two side frames being composed of two foot rods and a top lateral rod extending between the two foot rods; and

at least one armrest mounted on the top lateral rod on one of the two side frames.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a conventional walking accessory in accordance with the prior art;

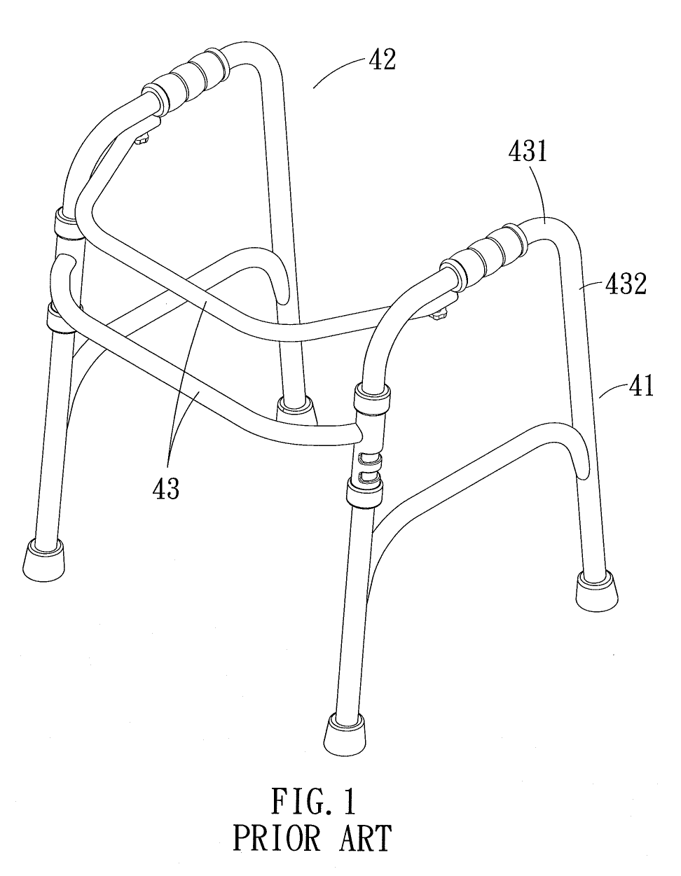

FIG. 2 is a perspective view of a walker with armrests in accordance with the present invention;

FIG. 3 is an operational perspective view of the walker, wherein the telescoping tubes are extended;

FIG. 4 is an exploded perspective view of the walker in FIG. 3; and

FIG. 5 is an operational side view of the walker in accordance with present invention.

### DETAILED DESCRIPTION OF THE PREFERRED EMBODIMENT

A walker with armrests in accordance with the present invention has a pedestal comprises a first side frame and a second side frame and two bridging rods connecting between the first and second side frames to perform a stable structure to the pedestal. The two side frames each have two spaced foot rods and a top lateral rod extending between the two foot rods. Two armrests are mounted on the top lateral rods on the first and second side frames respectively. Thereby, a physiotherapy patient enables to rest his armpits on the armrests to avoid leaning forward when holding the top lateral rods of the walker.

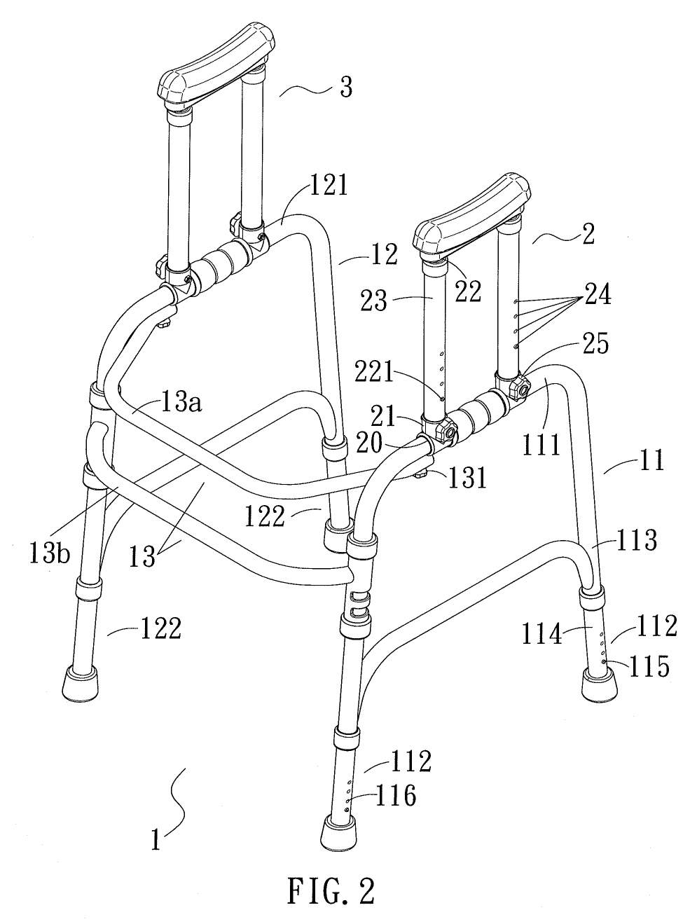

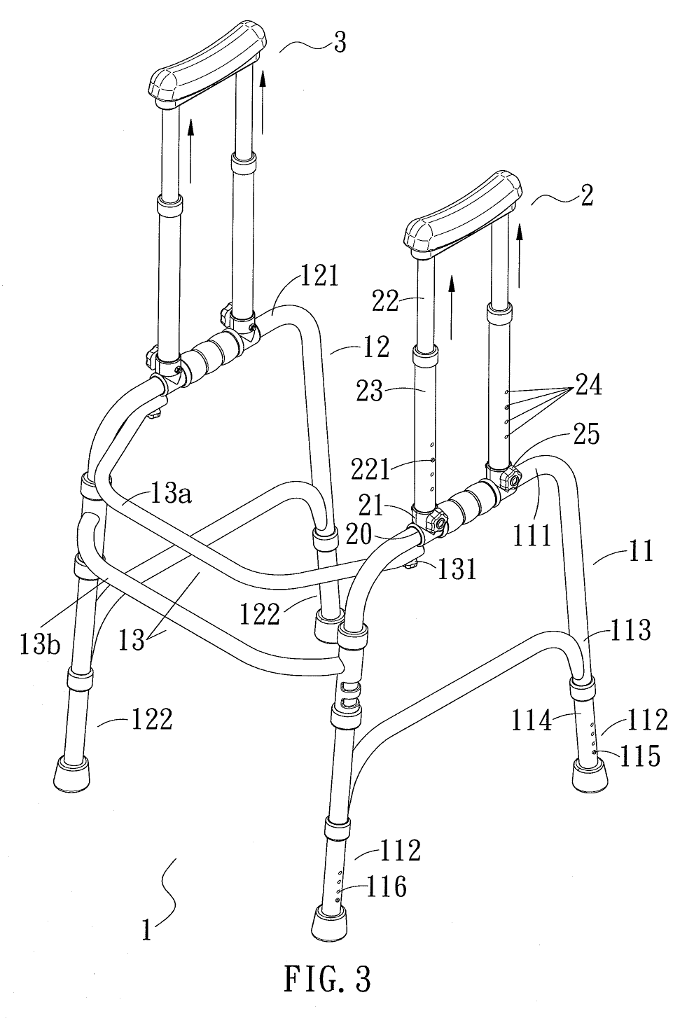

With reference to FIGS. 2 and 3, a preferred embodiment of the walker with armrests comprises a pedestal 1 and two inverted U-shaped side frames, a first side frame 11 and a second side frame 12, each being performed by a top lateral rod 111, 121 and two foot rods 112, 122 extending from two ends of the top lateral rod 111, 121 respectively. Each foot rod 112, 122 is a retractable structure composed of an inner tube 113 and an outer tube 114. The inner tube 113 has a resilient stub 115 and the outer tube 114 has multiple adjusting holes 116 operationally engaging with the resilient stub 115 on the inner tube 113 to selectively locate so that a user can adjust the length of the pedestal 1 by adjusting the foot rods 112, 122 to fit the user's height for convenient walking.

The two side frames 11, 12 are connected by a connecting portion 13 in configuration of two bridging rods 13a, 13b for example. One bridging rod 13a is attached to the two side frames 11, 12 at two ends respectively by two engaging elements 131. Another bridging rod 13b is also attached to the two side frames 11, 12 at two ends respectively and arranged with the bridging rod 13a in parallel. Thereby, the pedestal 1 in this invention has four standing feet to provide a stable support for users with inconvenient legs.

At least one armrest 2 is mounted on the top lateral rod 111 on the first side frame 11. The preferred embodiment as shown in FIGS. 2 and 3 have two armrests 2 mounted on the first and second side frames 11, 12 respectively. To avoid redundant description, only one armrest 2 on the first side frame 11 is described below since the two armrests 2 are same in structure.

The armrest 2 in this invention enables to be integral with the first side frame 11. Alternatively, as shown in FIGS. 2 to 4, the armrest 2 is detachable and substantially has two stands each having a joint piece 21 with a passage 20 sleeving the top lateral rod 111. The joint piece 21 is divided into two symmetrical parts for assembling convenience and has a threading knob 25 penetrating the two symmetrical parts for securing the joint piece on the corresponding stand of the armrest 2. Selectively, the armrest 2 in the present invention enables to be one accessory to mount on other obtainable walkers.

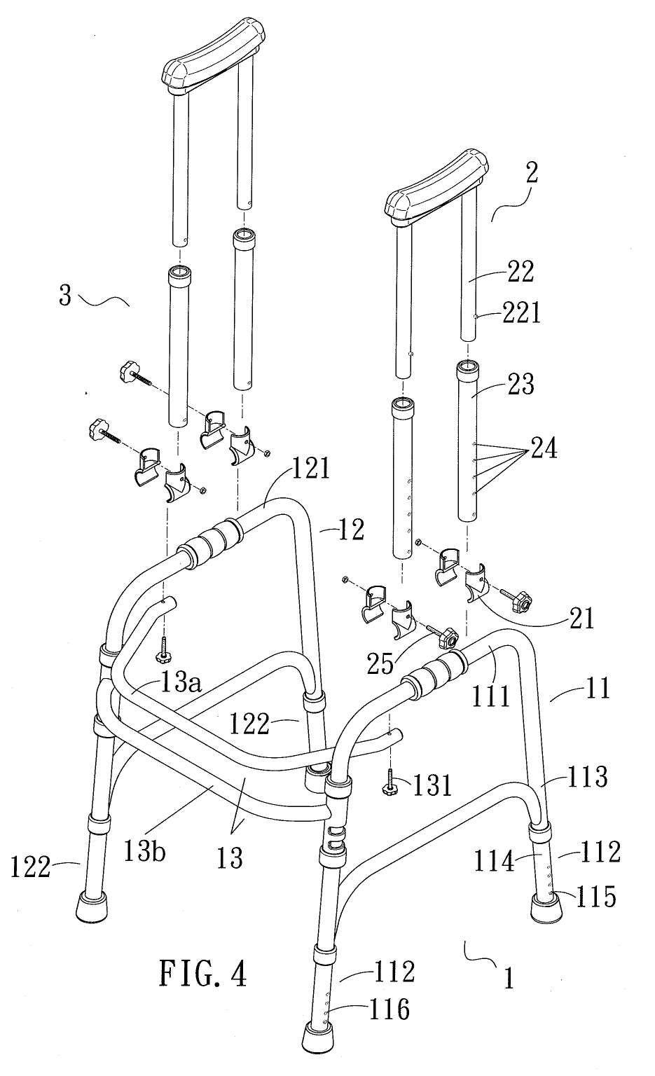

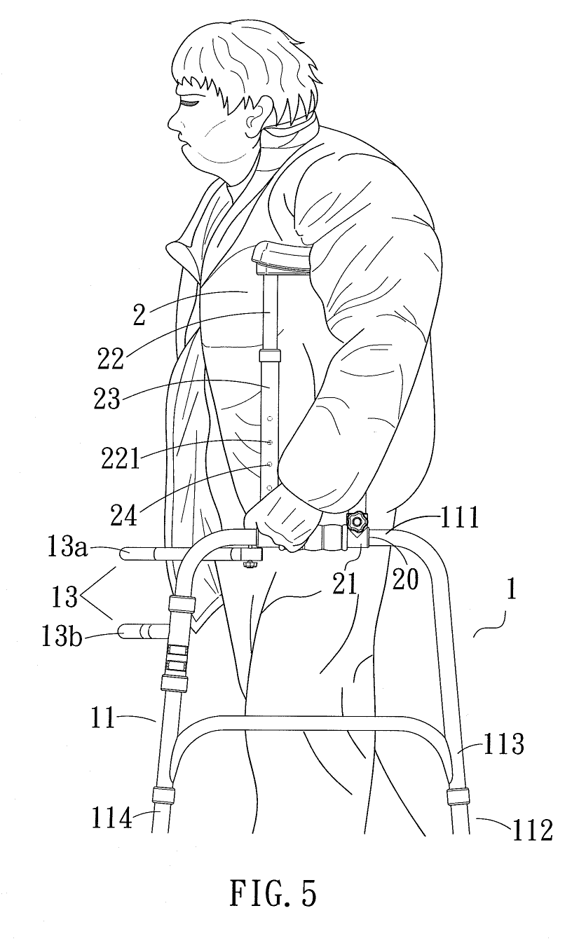

As shown in FIG. 4, because different users has different body sizes in arms and legs, the armrest 2 is selectively modified to be retractable and is a U-shaped body having the two stands, particularly two telescoping stands, each including an inner tube 22 and an outer tube 23. The inner tube 22 has a resilient stub 221 and the outer tube 23 has multiple adjusting holes 24 to snugly engage with the resilient stub 221 so that a user can adjust the height of the armrest 2 by adjusting the inner and outer tubes 22, 23 to fit the user's arm length for convenient holding the pedestal 1 by resting armpits on the armrests as shown in FIG. 5.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

1. (canceled)

2. The walker with armrests as claimed in claim 7, wherein two armrests are mounted on the top lateral rods of the two side frames, respectively.

3-4. (canceled)

5. The walker with armrests as claimed in claim 7, wherein each of the at least one armrest is U-shaped and has two telescoping stands; and
each of the two telescoping stands is composed of an inner tube with a resilient stub and an outer tube sleeving the inner tube and having multiple adjusting holes to snugly and selectively engage with the resilient stub on the inner tube, with the second passage of the joint piece sleeving the outer tube.

6. The walker with armrests as claimed in claim 2, wherein each of the two armrests is U-shaped and has two telescoping stands; and
each of the two telescoping stands is composed of an inner tube with a resilient stub and an outer tube sleeving the inner tube and having multiple adjusting holes to snugly and selectively engage with the resilient stub on the inner tube, with the second passage of the joint piece sleeving the outer tube.

7. A walker with armrests comprising:
a pedestal having two side frames and a connecting portion connected between the two side frames, with each of the two side frames including two foot rods and a top lateral rod extending between the two foot rods;
at least one armrest mounted on the top lateral rod on one of the two side frames; and
a joint piece having a first passage to sleeve the top lateral rod of the one of the two side frames and a second passage to sleeve the at least one armrest, with the second passage terminating in the first passage to create a T-shape, wherein the joint piece is divided into two, separate, symmetrical parts each having half of each of the first and second passages, and wherein the joint piece has a threading knob with a nut penetrating the two symmetrical parts for securing the two symmetrical parts together and securing the joint piece to the top lateral rod and to the at least one armrest.

8. (canceled)

9. The walker with armrests as claimed in claim 7, wherein each of the two foot rods is composed of an inner tube with a resilient stub and an outer tube sleeving the inner tube and having multiple adjusting holes to snugly and selectively engage with the resilient stub on the inner tube.

10-11. (canceled)

12. An armrest adapted to mount on a walker, comprising:
a U-shaped body having two stands;
each of the two stands having a bottom; and
a joint piece mounted at the bottom of each of the two stands, wherein the joint piece has a first passage to sleeve the corresponding portion of the walker and a second passage sleeving the bottom of the stand, with the second passage terminating in the first passage to create a T-shape, wherein the joint piece is divided into two, separate, symmetrical parts for assembling convenience and each having half of each of the first and second passages, and wherein the joint piece has a threading knob penetrating the two symmetrical parts for securing the two symmetrical parts together and the joint piece on the corresponding stand of the armrest and the corresponding portion of the walker.
